(19) United States
(12) Patent Application Publication
(10) Pub. No.: US 2011/0095527 A1
(43) Pub. Date: Apr. 28, 2011

(54) PIPE CONNECTION DEVICE AND PIPE STRUCTURE

(76) Inventor: Tatsuki Miyoshi, Chiba (JP)

(21) Appl. No.: 13/001,068

(22) PCT Filed: Jun. 26, 2008
(86) PCT No.: PCT/JP2008/001661

§ 371 Date: Dec. 23, 2010

(51) Int. Cl. F16L 25/00

(52) U.S. Cl. 285/334.1; 285/328

(57) ABSTRACT

The present invention provides a novel pipe connection device for connecting pipes using two or more combined synthetic resin moldings, and a pipe structure. The pipe connection device includes a base member constituted by a polyhedron, at least two surfaces thereof each being formed with a projecting portion, and a connection member that is inserted into a part of a tubular pipe and connected to the base member. The base member is constructed by combining the two or more synthetic resin moldings, each formed with a part of the projecting portion, and the connection member is externally fitted to the projecting portion such that the two or more synthetic resin moldings are fixed in a combined state.

### TECHNICAL FIELD

The present invention relates to a technique for connecting pipes.

### BACKGROUND ART

An assembly structure for displaying articles for sale or the like has been proposed in the prior art. In this assembly structure, a tubular joint member is attached to a fulcrum member constituted by a polyhedron made of wood or metal, and a tubular cardboard pipe is fitted to one end of the attached joint member (see Patent Document 1).

Patent Document 1: Japanese Registered Utility Model Publication No. 3007988

However, when a fulcrum member is made of wood or metal, as in the assembly structure for displaying articles for sale or the like described above, problems arise in the assembled structure due to the likelihood of rotting (when the fulcrum member is made of wood), the likelihood of breakage (when the fulcrum member is made of wood), increases in labor and cost (when the fulcrum member is made of metal), and so on.

When a fulcrum member such as that described above is made of synthetic resin, on the other hand, the fulcrum member must be constructed by combining two or more synthetic resin moldings due to injection molding limitations, but Patent Document 1 makes no mention of a method for fixing two or more combined synthetic resin moldings.

### DISCLOSURE OF THE INVENTION

An object of the present invention is therefore to provide a novel pipe connection device for connecting pipes using two or more combined synthetic resin moldings, as well as a pipe structure.

According to the present invention, the object described above is solved by the following means.

The present invention is a pipe connection device including a base member constituted by a polyhedron, at least two surfaces thereof each being formed with a projecting portion, and a connection member that is inserted into a part of a tubular pipe and connected to the base member, wherein the base member is constructed by combining two or more synthetic resin moldings, each formed with a part of the projecting portion, and the connection member is externally fitted to the projecting portion such that the two or more synthetic resin moldings are fixed in a combined state.

With the pipe connection device according to the present invention, the base member is formed from the two or more synthetic resin moldings, and the two synthetic resin moldings are fixed in a combined state by externally fitting the connection member to the projecting portions. Therefore, with the pipe connection device according to the present invention, the two or more combined synthetic resin moldings can be fixed easily and firmly without using screws or the like.

According to the present invention, a novel pipe connection device for connecting pipes using two or more combined synthetic resin moldings, as well as a pipe structure, can be provided.

### BRIEF DESCRIPTION OF THE DRAWINGS

FIG. 1 is a schematic view showing a constitution of a pipe connection device according to a first embodiment;

FIG. 2 is a schematic view showing a constitution of a base member 10;

FIG. 3 is a schematic view showing a constitution of a pipe connection device according to a second embodiment;

FIG. 4 is a schematic view showing a constitution of a base member 60;

FIG. 5 is a schematic view showing a constitution of a lid member 90 according to an embodiment;

FIG. 6 is a schematic view showing a constitution of a pipe structure according to an embodiment; and

FIG. 7 is a view showing another example of a connection member according to an embodiment.

### EXPLANATION OF REFERENCE NUMERALS

1 pipe connection device
2 pipe connection device
3 pipe structure
10 base member
10a first base member
10b second base member
20 projecting portion
20a part of projecting portion
20b part of projecting portion
21 screw groove
21a part of screw groove
21b part of screw groove
30 connection member
31 screw groove
32 protruding portion
40 cardboard pipe
51 projecting portion
52 recessed portion
60 base member
60a first base member
60b second base member
70 hole
80 strut
81 shaft portion
82 lid portion
90 lid member
91 screw groove
100 connection member
110 site having cross-shaped cross-section
120 cylindrical portion having C-shaped cross-section
121 screw groove

### BEST MODES FOR CARRYING OUT THE INVENTION

Embodiments of the present invention will be described in detail below with reference to the attached drawings.

[Pipe Connection Device According to First Embodiment]

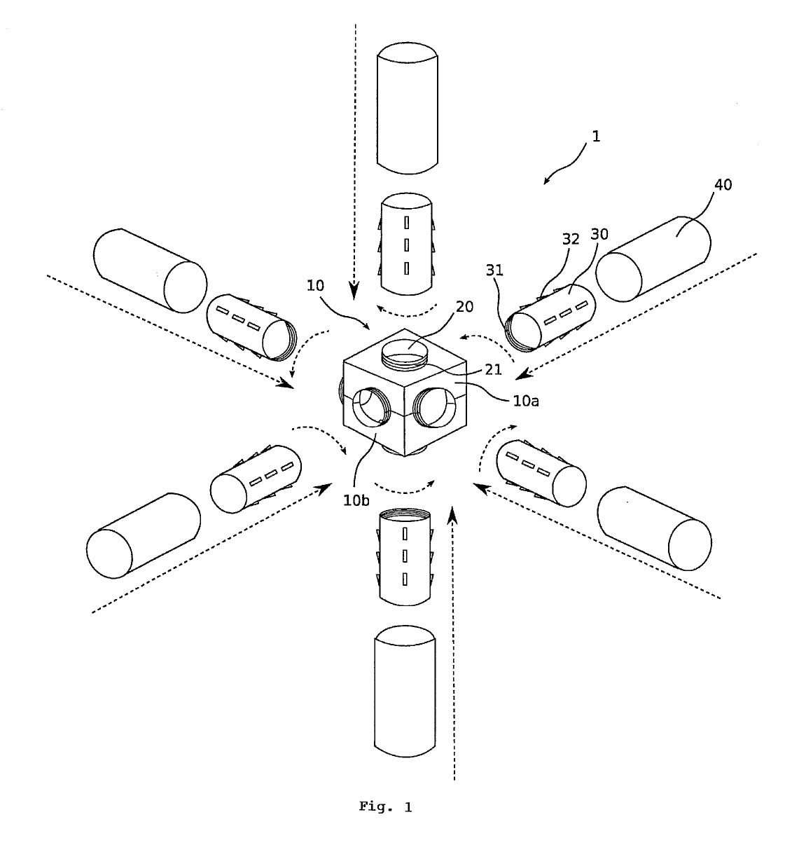

FIG. 1 is a schematic view showing a constitution of a pipe connection device according to a first embodiment. As shown in FIG. 1, a pipe connection device 1 according to the first embodiment includes a base member 10 constituted by a hexahedron and a cylindrical connection member 30.

Six cylindrical projecting portions 20 are formed on the respective surfaces of the base member 10, and a screw groove 21 is formed on an outer periphery of each cylindrical projecting portion 20. Further, the base member 10 is constructed by combining a first base member 10a and a second base member 10b.

The first base member 10a and the second base member 10b are both synthetic resin moldings, and a part of the cylindrical projecting portion 20 (a semi-cylindrical projecting portion 20a or 20b) is formed on each surface thereof.

The cylindrical connection member 30 is inserted into a part of a cylindrical cardboard pipe 40 and connected to each surface of the base member 10. The cylindrical connection member 30 is connected to each surface of the base member 10 by being externally fitted to the cylindrical projecting portion 20 formed on each surface of the base member 10.

To describe this in more detail, a screw groove 31 that is screwed to the screw groove 21 formed on the outer periphery of the cylindrical projecting portion 20 formed on each surface of the base member 10 is formed on an inner periphery of the cylindrical connection member 30, and by screwing the screw groove 31 formed on the inner periphery of the cylindrical connection member 30 to the screw groove 21 formed on the outer periphery of the cylindrical projecting portion 20 formed on each surface of the base member 10, the cylindrical connection member 30 is externally fitted to the cylindrical projecting portion 20 formed on each surface of the base member 10.

When the cylindrical connection member 30 is externally fitted to the cylindrical projecting portion 20 formed on each surface of the base member 10 in this manner, the first base member 10a and the second base member 10b are fixed in a combined state.

Note that protruding portions 32 are formed on an outer periphery of the cylindrical connection member 30 to prevent positional deviation between the cylindrical connection member 30 and the cardboard pipe 40 following insertion.

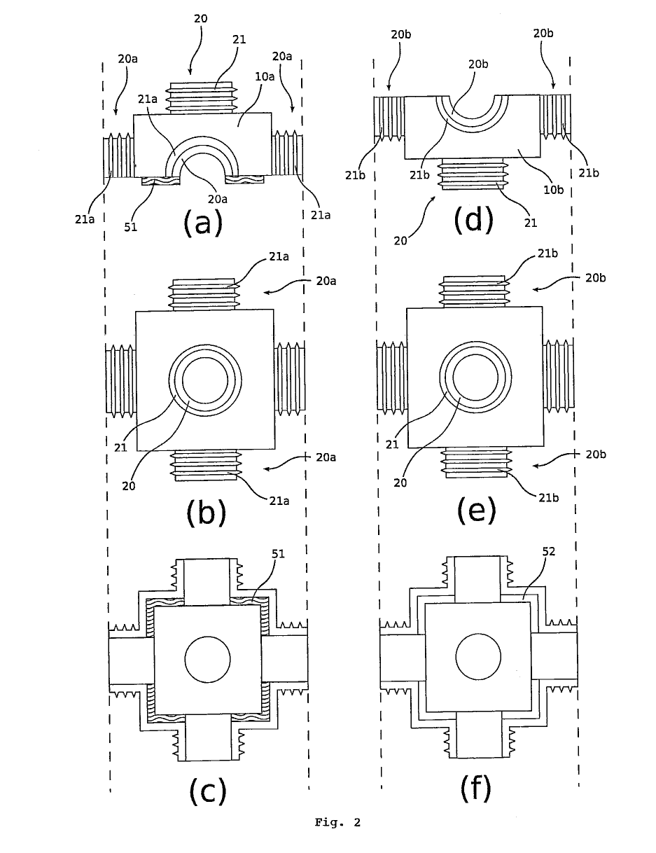

FIG. 2 is a schematic view showing a constitution of the base member 10, wherein FIG. 2A is a schematic side view of the first base member 10a, FIG. 2B is a schematic plan view of the first base member 10a, FIG. 2C is a schematic rear view of the first base member 10a, FIG. 2D is a schematic side view of the second base member 10b, FIG. 2E is a schematic plan view of the second base member 10b, and FIG. 2F is a schematic rear view of the second base member 10b.

As shown in FIG. 2, four semi-cylindrical projecting portions 20a are formed on four side faces of the first base member 10a, and four semi-cylindrical projecting portions 20b are formed on four side faces of the second base member 10b. Further, a single cylindrical projecting portion 20 is formed on each of the first base member 10a and the second base member 10b.

Furthermore, a projecting portion 51 (a wavy line part in FIG. 2) is formed on a rear surface of the first base member 10a, and a recessed portion 52 is formed in a rear surface of the second base member 10b.

The recessed portion 52 of the second base member 10b has a slightly larger dimension than the projecting portion 51 (the wavy line part in FIG. 2) of the first base member 10a. Therefore, when the projecting portion 51 (the wavy line part in FIG. 2) formed on the rear surface of the first base member 10a is fitted into the recessed portion 52 formed in the rear surface of the second base member 10b, the first base member 10a and second base member 10b are fitted together in an unfixed state (i.e. so that they can be separated easily).

As a result, the four semi-cylindrical projecting portions 20a formed on the four side faces of the first base member 10a and the four semi-cylindrical projecting portions 20b formed on the four side faces of the second base member 10b are aligned such that when the first base member 10a and the second base member 10b are combined, four cylindrical projecting portions 20 are formed on the four side faces of the base member 10. Accordingly, one cylindrical projecting portion 20 is formed on each surface of the base member 10, and therefore the base member 10 includes a total of six cylindrical projecting portions 20.

[Pipe Connection Device According to Second Embodiment]

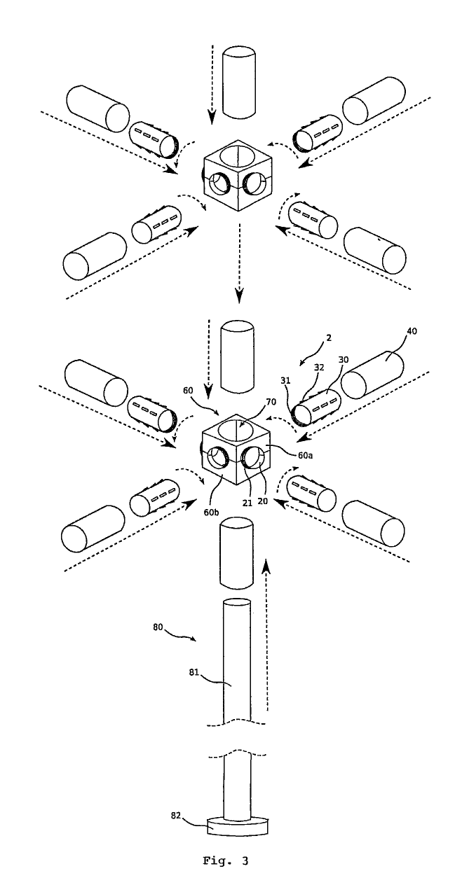

FIG. 3 is a schematic view showing a constitution of a pipe connection device according to a second embodiment. As shown in FIG. 3, a pipe connection device 2 according to the second embodiment differs from the pipe connection device 1 according to the first embodiment in having a base member 60 formed with circular holes 70 in an upper surface and a lower surface thereof.

In the pipe connection device 2 according to the second embodiment, a strut member 80 including a shaft portion 81 and a lid portion 82 penetrates the cylindrical cardboard pipe 40 and the circular holes 70 formed in the upper surface and lower surface of the base member 60, and thereby supports the base member 60.

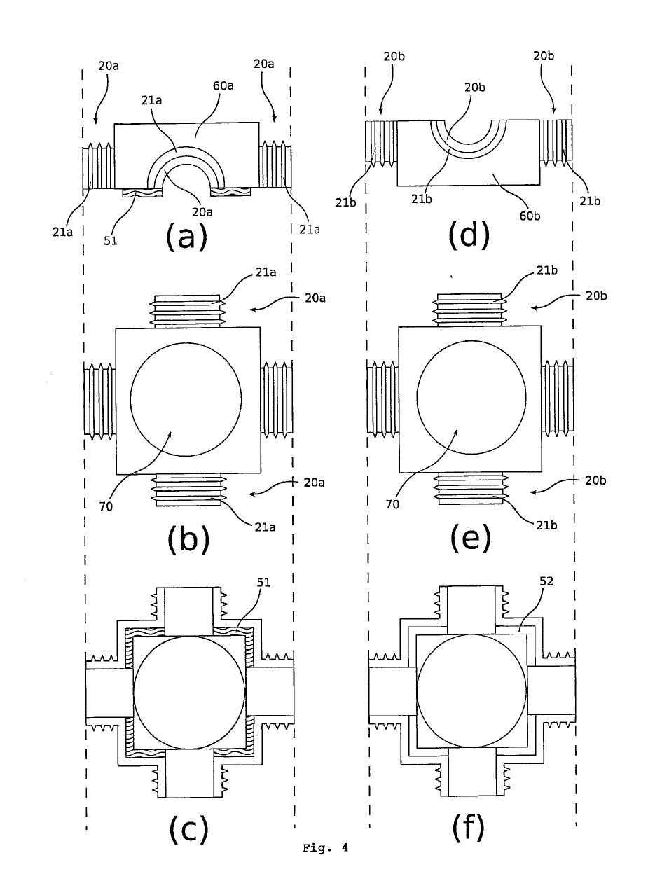

FIG. 4 is a schematic view showing a constitution of the base member 60, wherein FIG. 4A is a schematic side view of a first base member 60a, FIG. 4B is a schematic plan view of the first base member 60a, FIG. 4C is a schematic rear view of the first base member 60a, FIG. 4D is a schematic side view of a second base member 60b, FIG. 4E is a schematic plan view of the second base member 60b, and FIG. 4F is a schematic rear view of the second base member 60b.

As described above, in the pipe connection device 2 according to the second embodiment, the circular holes 70 are formed in the upper surface and the lower surface of the base member 60.

[Lid Member According to an Embodiment]

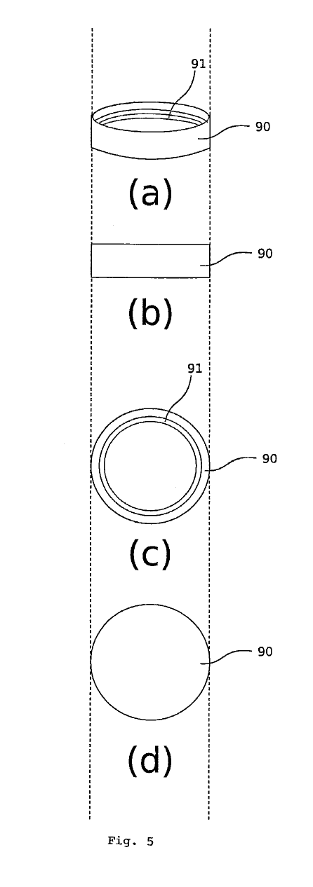

FIG. 5 is a schematic view showing a constitution of a lid member 90 according to an embodiment, wherein FIG. 5A is a schematic perspective view of the lid member 90, FIG. 5B is a schematic side view of the lid member 90, FIG. 5C is a schematic rear view of the lid member 90, and FIG. 5D is a schematic plan view of the lid member 90.

As shown in FIG. 5, a screw groove 91 that is screwed to the screw groove 21 of the cylindrical projecting portion 20 formed on each surface of the base member 10 (the base member 60) is formed on an inner periphery of the lid member 90.

In the pipe connection device 1 according to the first embodiment (the pipe connection device 60 according to the second embodiment), the lid member 90 may be connected to the cylindrical projecting portion 20 formed on each surface of the base member 10 (the base member 60) instead of the connection member 30. In this case, when the lid member 90 is externally fitted to the cylindrical projecting portion 20 formed on each surface of the base member 10 (the base member 60), the first base member 10a (the first base member 60a) and the second base member 10b (the second base member 60b) are fixed in a combined state.

[Pipe Structure According to an Embodiment]

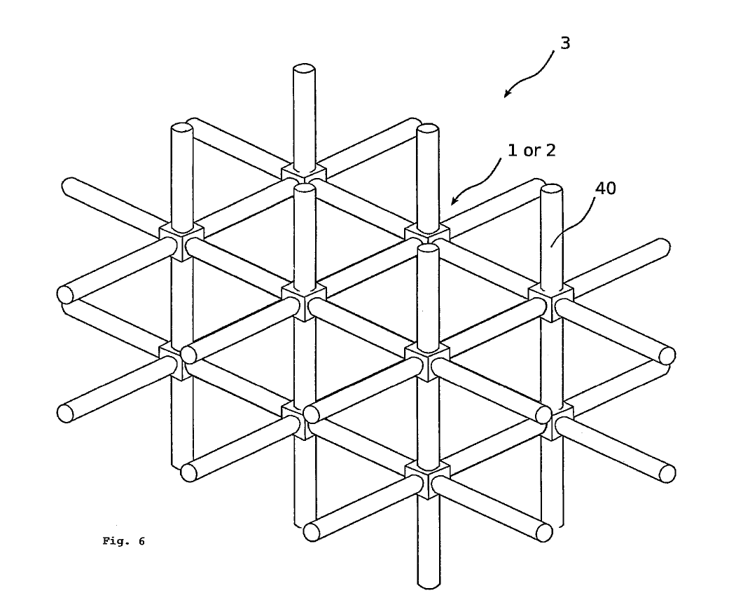

FIG. 6 is a schematic view showing a constitution of a pipe structure according to an embodiment. As shown in FIG. 6, a pipe structure 3 according to an embodiment is constructed by connecting a plurality of cardboard pipes using the first pipe connection device 1 (the second pipe connection device 2).

As described above, according to the first pipe connection device 1 (the second pipe connection device 2), the base member 10 (the base member 60) is constructed by combining the first base member 10a (the first base member 60a) and the second base member 10b (the second base member 60b), and the connection member 30 is externally fitted to the projecting portion 20 such that the first base member 10a (the first base member 60a) and the second base member 10b (the second base member 60b) are fixed in a combined state.

Therefore, according to the first pipe connection device 1 (the second pipe connection device 2), the combined first base member 10a (first base member 60a) and second base member 10b (second base member 60b) can be fixed easily and firmly without using screws or the like.

Further, according to the first pipe connection device 1 (the second pipe connection device 2), the first base member 10a (the first base member 60a) and the second base member 10b (the second base member 60b) are externally fitted and fixed by screwing together the screw grooves 21, 31, rather than with the use of a fixing engagement pawl (which is difficult to detach and easy to break) or the like. Hence, when the pipe connection device is disassembled, the external fitting generated by the connection member 30 can be released easily, and damage to the base member, the connection member, and so on can be prevented while releasing the external fitting.

[Pipe]

Any tubular pipe may be employed. A rounded tubular pipe, an angular tubular pipe, and so on, for example, may be used as the tubular pipe.

Further, there are no particular limitations on the material of the pipe. Hence, instead of the cardboard pipe described above, a resin pipe, an aluminum pipe, and so on, for example, may be used as the pipe. However, a cardboard pipe can be used particularly favorably with the pipe connection device according to the present invention due to its low weight, durability, environmental friendliness, and so on.

[Base Member]

Any polyhedron (a solid having four or more surfaces) may be used as the base member, and instead of the hexahedron described above, a tetrahedron, a heptahedron, a dodecahedron, and so on, for example, may be used as the base member.

The base member is used to connect the tubular pipes, and therefore the projecting portions must be formed on at least two surfaces thereof.

There are no particular limitations on the shape of the projecting portion formed on the base member as long as the connection member can be externally fitted thereto, and instead of the cylindrical shape described above, a regular hexahedron, a rectangular parallelepiped, and so on, for example, may be used as the projecting portion formed on the base member.

Any base member that is constructed by combining two or more synthetic resin moldings may be used. Therefore, instead of constructing the base member by combining two synthetic resin moldings, the base member may be constructed by combining three synthetic resin moldings or four synthetic resin moldings, for example.

A part of the projecting portion is formed on each of the two or more synthetic resin moldings constituting the base member, and therefore, by externally fitting the connection member to a single entire projecting portion constituted by these parts of the projecting portion, the two or more synthetic resin moldings are fixed in a combined state, thereby forming the single base member.

Any two or more synthetic resin moldings that can be combined may be employed, but as described above, the two or more synthetic resin moldings are preferably shaped so that they can only be combined in an aligned state. Here, an aligned state indicates a state in which the two or more synthetic resin moldings are aligned, or in other words a state in which entire projecting portions are fully formed on the surface of the base member. In so doing, the two or more synthetic resin moldings can be aligned easily.

In a case where the two or more synthetic resin moldings are shaped so that they can only be combined in an aligned state, a projecting portion and a recessed portion or the like that can only be fitted together when the two or more synthetic resin moldings are in the aligned state are formed as illustrated in the above embodiment (i.e. the projecting portion and the recessed portion are formed in positions where, if an attempt is made to combine the two or more synthetic resin moldings in an unaligned state, the recessed portion corresponding to the projecting portion does not exist, and therefore the projecting portion causes an obstruction such that the two or more synthetic resin moldings cannot be combined). Alternatively, the two or more synthetic resin moldings are formed to be symmetrical in a perpendicular plane to a combining direction.

Note that when the projecting portion and the recessed portion are formed as described above, the projecting portion may be formed in the shape of a regular hexahedron, a rectangular parallelepiped, a narrow cylinder, a needle-shaped body, a small hemispherical protrusion, and so on, and the recessed portion may be formed in a corresponding shape.

When the projecting portion and recessed portion or the like described above are formed in the two or more synthetic resin moldings, the projecting portion and recessed portion or the like are preferably shaped such that the two or more synthetic resin moldings can be combined in an unfixed state (so that they can be separated easily).

In so doing, the two or more synthetic resin moldings can be switched between a fixed state and an unfixed state by externally fitting and removing the connection member, and therefore the base member can be disassembled easily while preventing damage to the synthetic resin moldings during disassembly.

When the projecting portion and recessed portion or the like are shaped such that the two or more synthetic resin moldings constituting the single base member can be combined in an unfixed state, a projecting portion and an indented recessed portion that is slightly larger than the projecting portion, such as those described above, for example, are formed respectively on the two or more synthetic resin moldings.

Note that the synthetic resin molding may be manufactured by injection-molding polypropylene (PP), polyethylene (PE), acrylonitrile butadiene styrene (ABS), polyacetal (PM), polystyrene (PS), and so on, for example.

[Connection Member]

The connection member includes an insertion portion that is inserted into a part of the tubular pipe and an external fitting portion that is externally fitted to the projecting portion formed on the base member. Instead of the cylindrical connection member described above, an angular tube-shaped connection member, a connection member to be described below, and so on, for example, may be used as the connection member.

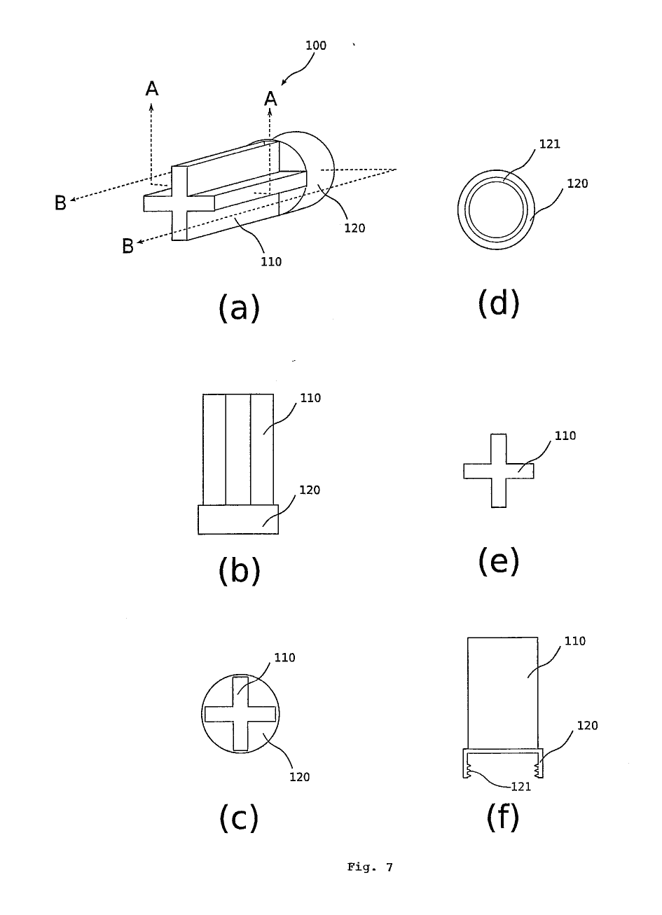

FIG. 7 is a view showing another example of the connection member according to an embodiment, wherein FIG. 7A is a schematic perspective view of the connection member according to the other example, FIG. 7B is a schematic plan view of the connection member according to the other example, FIG. 7C is a schematic left side view of the connection member according to the other example, FIG. 7D is a schematic right side view of the connection member according to the other example, FIG. 7E is an A-A sectional view of FIG. 7A, and FIG. 7F is a B-B sectional view of FIG. 7A.

As shown in FIG. 7, a connection member 100 according to the other example includes a site 110 (an example of the insertion portion) having a cross-shaped cross-section, and a cylindrical portion 120 (an example of the external fitting portion) having a C-shaped cross-section. The site 110 having a cross-shaped cross-section is inserted into a part of the tubular cardboard pipe 40, and the cylindrical portion 120 having a C-shaped cross-section is externally fitted to the projecting portion 20 formed on the base member 10 (the base member 60). Note that a screw groove 121 that is screwed to the screw groove 21 formed on the outer periphery of the projecting portion 20 of the base member 60 is formed on an inner periphery of the cylindrical portion 120 having a C-shaped cross-section.

To ensure that the connection member can be inserted into both ends of a single pipe, a length of the connection member is set at the dimension that is inserted into a part of the pipe, or in other words set to be shorter than the pipe.

The connection member is externally fitted to the projecting portion formed on the base member. In the above embodiment, a screw fitting, or in other words a fitting formed by screwing, was described as an example of the external fitting, but the external fitting is not limited to a screw fitting. When the two or more synthetic resin moldings are combined in an unfixed state, however, the two or more synthetic resin moldings must be fixed more firmly using the connection member, and in this case a screw fitting is particularly preferable as the external fitting.

Note that a shelf, a wall, and so on can be constructed by mounting or fitting plates or the like made of paper, glass, metal, or wood onto or into a pipe structure formed by connecting a plurality of pipes using the pipe connection device according to the present invention.

With the pipe connection device according to the present invention, a pipe structure can be constructed and disassembled easily. Hence, the pipe connection device according to the present invention can be used particularly favorably to construct household furniture and office furniture such as bookshelves, desks, chairs, and partitions, for example. The pipe connection device according to the present invention can also be used particularly favorably to construct an industrial product transportation device such as a rack.

Embodiments of the present invention were described above, but the description of these embodiments relates to a single example of the present invention, and the present invention is not limited in any way to the above description.

1. A pipe connection device comprising a base member constituted by a polyhedron, at least two surfaces thereof each being formed with a projecting portion, and a connection member that is inserted into a part of a tubular pipe and connected to the base member,
wherein the base member is constructed by combining two or more synthetic resin moldings, each formed with a part of the projecting portion, and
the connection member is externally fitted to the projecting portion such that the two or more synthetic resin moldings are fixed in a combined state.

2. The pipe connection device according to claim 1, wherein the two or more synthetic resin moldings are formed in a shape that allows the two or more synthetic resin moldings to be combined only in an aligned state.

3. The pipe connection device according to claim 2, wherein the two or more synthetic resin moldings are formed in a shape that allows the two or more synthetic resin moldings to be combined in an unfixed state.

4. A pipe structure characterized by being formed by connecting a plurality of pipes using the pipe connection device according to claim 1.

5. A pipe structure characterized by being formed by connecting a plurality of pipes using the pipe connection device according to claim 2.

6. A pipe structure characterized by being formed by connecting a plurality of pipes using the pipe connection device according to claim 3.
